(19) United States
(12) Patent Application Publication
(10) Pub. No.: US 2008/0238084 A1
(43) Pub. Date: Oct. 2, 2008

(54) Basic hoisting ring labeling means

(76) Inventor: Steven Hung, Taichung Industrial Park (TW)

Correspondence Address: TROXELL LAW OFFICE PLLC, SUITE 1404, 5205 LEESBURG PIKE, FALLS CHURCH, VA, 22041, US

(21) Appl. No.: 11/727,411

(22) Filed: Mar. 26, 2007

(51) Int. Cl. G09F 3/00

(52) U.S. Cl. 283/81

(57) ABSTRACT

A basic hoisting ring labeling means to provide clear and permanent label for safe operation includes a hook, a cylindrical base, a threaded bolt, and an annual recess; the hook being coupled to the cylindrical base, the threaded bolt securing a work piece; the annual recess defining an area to show specification information specific to the ring, highlighted by a particular base color, and shield from impacts and frictions from and with other objects to maintain always clear and legible to avoid dangers resulted from drop of the work piece due to broken hoisting ring when a wrong basic hoisting ring is selected.

### BACKGROUND OF THE INVENTION

(a) Field of the Invention

The present invention is related to a basic hoisting ring labeling means, and more particularly, to one that provides permanent labeling effects and easy and clean-cut identification by having an annular recess on a side middle section of a cylindrical base of the basic hoisting ring to define a divide for printing or sticking letters or color on the bottom of the divide necessarily to identify the applicable specification of that specific hoisting ring.

(b) Description of the Prior Art

A basic hoisting ring is provided with a cylindrical base with preset a threaded rod to engage with a threaded slot preset on a heavy-duty work piece (e.g., a mold) to couple and secure the ring and the work piece to each other; and a mobile made in an inverse U-shape hook disposed on an upper section of the base is then coupled with a chock disposed on a lower section of a hoisting mechanism to achieve safe operation of hoisting and moving the work piece. Before hoisting the work piece, a basic hoisting ring with a correct bearing capacity, strength specification or thread specification must be carefully selected depending on the weight and thread specification of the work piece. Any poor selection may result in danger to person and/or property since the work piece may drop due to the basic hoisting ring is broken in the course of operation. Therefore, the careful selection of a correct hoisting ring is a must before hoist operation.

Accordingly, in a middle portion on the perimeter of a cylindrical base of a basic hoisting ring of the prior art is marked necessary information including bearing capacity, strength, and thread specification of the basic hoisting ring in bright color and typeface to allow an operator to detect and identify by visual inspection for selecting a correct basic hoisting ring. However, as the basic hoisting ring is frequently subject to impact and friction in the shop area or in the course of operation, markings of those necessary information after a longer time of operation will be damaged, stripped or becoming illegible, and the user has to renew the markings or forthwith operate simply by memory. Series danger may happen when a work piece drops due to insufficient strength or specification nonconformity of the basic hoisting ring in case of different operator or those markings prevent clear recognition. Clear and persist labeling is the most crucial factor in the production of a basic hoisting ring other than factors of strength and construction.

### SUMMARY OF THE INVENTION

The primary purpose of the present invention is to provide a labeling means for a basic hoisting ring that allows clear reading and selection by user for each time of hoisting operation to achieve safe and convenient operating benefits while minimizing possible danger of choosing the wrong one. To achieve the purpose, a hook made in an inverse U shape is latched to both sides of a cylindrical base; an annular recess is disposed on the cylindrical base to provide markings including bearing capacity, strength, or thread specification and/or markings of color or typeface for identification purpose specific to that basic hoisting ring on the bottom of the annual recess for those markings to always allow clear and specific recognition while surviving impacts and frictions from and with a heavy-duty work piece.

Another purpose of the present invention is to provide a labeling means for a basic hoisting ring that allows economic benefits of cost reduction and summary process in providing crucial information on the basic hoisting ring. To achieve the purpose, those markings are provided simply by transferring typeface or color since they are disposed on the bottom of the annual recess and thus are immune from impacts and frictions from and with other objects. Therefore the present invention does not have to rely upon relief or engrave process that consumes higher costs and involves complicated process as found with the prior art.

### BRIEF DESCRIPTION OF THE DRAWINGS

FIG. 1 is a perspective view of a basic hoisting ring of a preferred embodiment of the present invention.

FIG. 2 is perspective view showing an operation status of the preferred embodiment of the present invention.

FIG. 2-A is a sectional view showing the operation status of the preferred embodiment of the present invention.

FIG. 3 is a side view of the preferred embodiment of the present invention.

FIG. 3-A is a schematic view showing a marking provided on the preferred embodiment of the present invention as illustrated in FIG. 3.

FIG. 4 is a side view of another preferred embodiment of the present invention.

FIG. 4-A is a schematic view showing a marking provided on another preferred embodiment of the present invention as illustrated in FIG. 4.

### DETAILED DESCRIPTION OF THE PREFERRED EMBODIMENTS

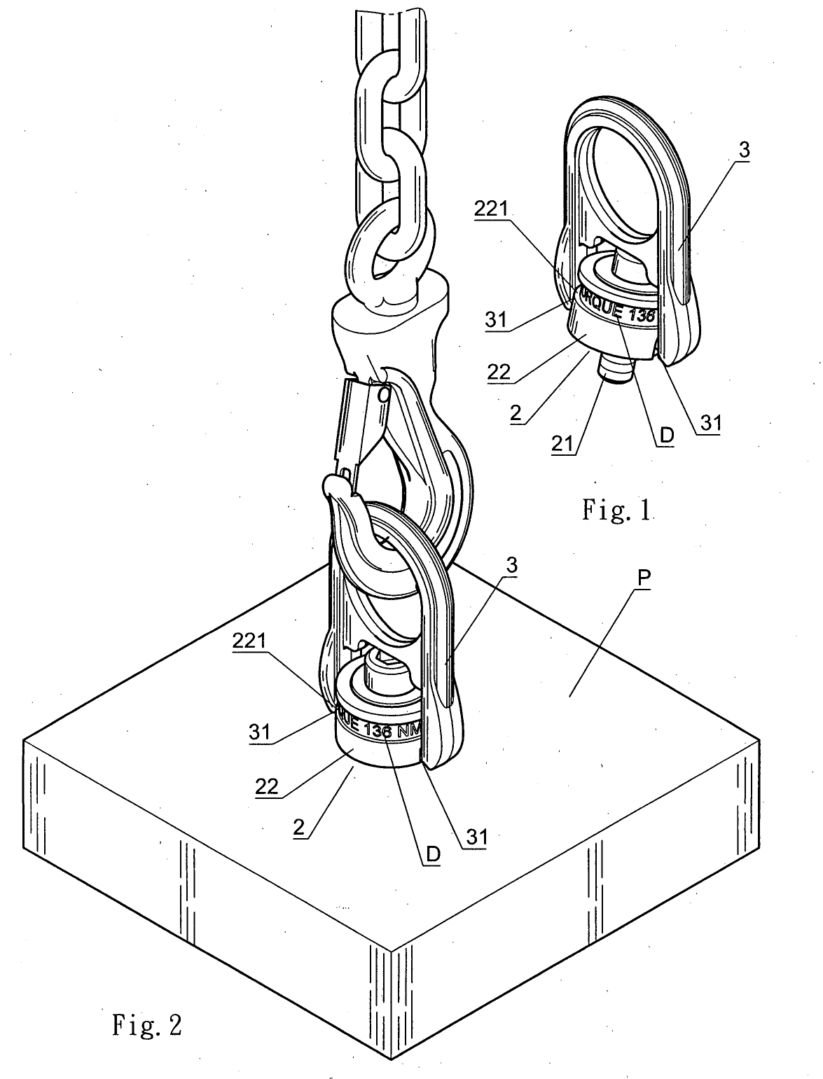

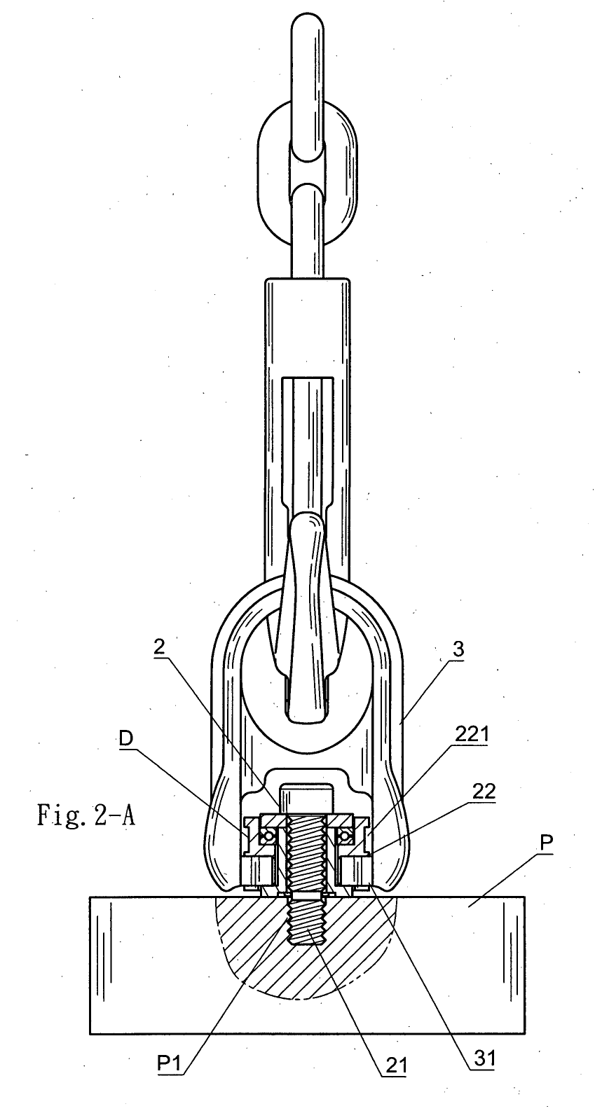

Referring to FIGS. 1, 2, and 2-A, a basic hoisting ring labeling means of the present invention includes a hook 3 made in an inverse U shape having both straight sides at their lower ends each provided with an inwardly protruding hook portion 31 inwardly for the hook 3 to be locked to both sides of a cylindrical base 2; and a threaded bolt 21 inserted into a middle section of the cylindrical base 2 and a certain lower section of the threaded bolt 21 being exposed out of the bottom of the cylindrical base 2 to engage with a threaded slot PI disposed to a work piece P located at where below the cylindrical base 2 for securing the cylindrical base 2 and the work piece P to each other.

An annual recess 221 is disposed around a middle section of the cylindrical base 2 to define a certain divide between a bottom of the recess 221 and a surface of the cylindrical base 2; and the bottom of the recess 221 is provided for printing or sticking a label D carrying necessary information including applicable specifications specific to the basic hoisting ring.

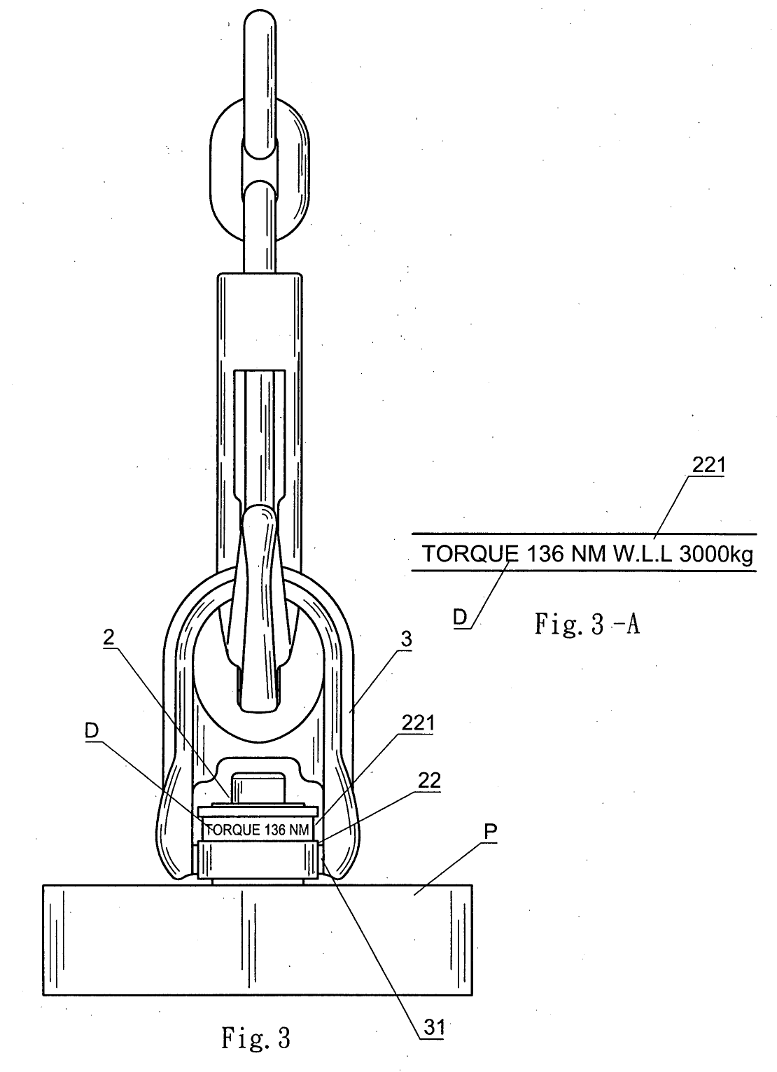

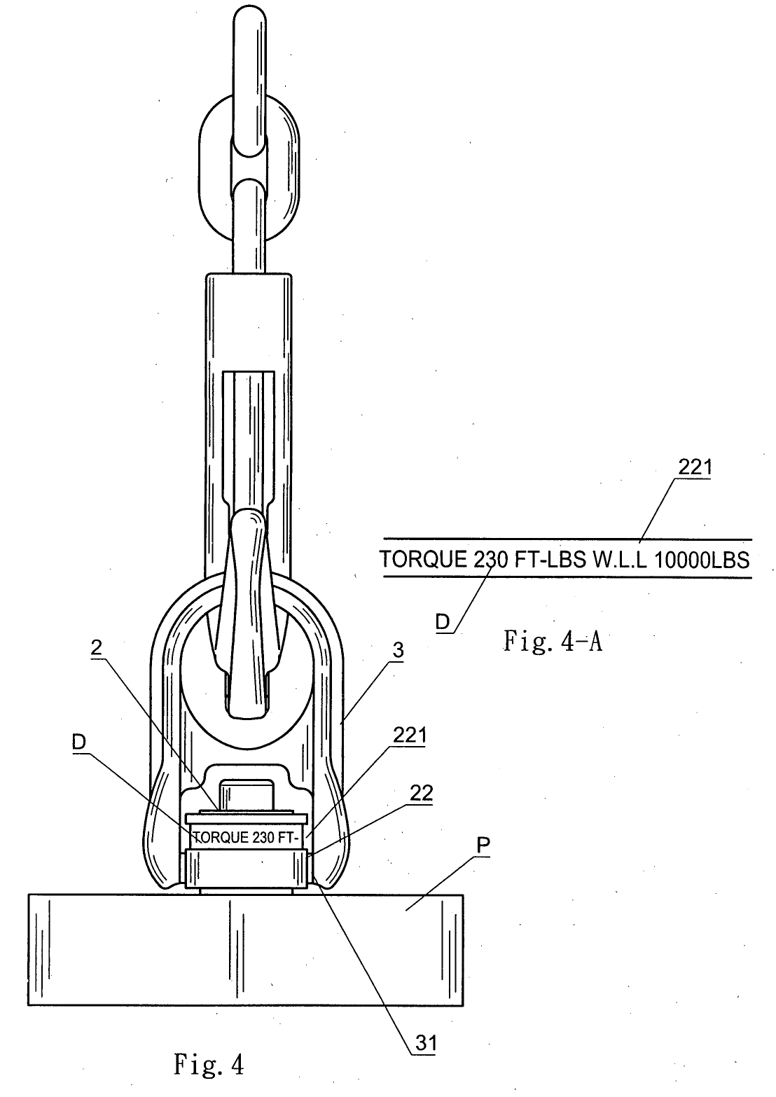

As illustrated in FIGS. 3, 3-A, 4, and 4-A, the label D may contain information including designation, thread specification (torque), unit adopted, and bearing capacity (work load limit). A base color may be highlighted to the recess 221 or a particular color may be painted on the typeface of the label D to distinguish the label D for helping identification. For example, the base color is painted in red to indicate that kilogram system is adopted for the unit of weight; and in blue, British pound system. Accordingly, the label D allows easy identification by an operator at a glance before selecting the correct basic hoisting ring.

As the contents of the label D provided on the bottom of the recess 221 is protected by the protruded surface of the cylindrical base 2, the label D is immune from being subject to impacts and frictions from and with other work pieces or the hoist ring to ensure durability of the label D as a permanent label.

Whereas the label D is capable of always maintaining a precise marking purpose, the operator upon hoisting a work piece S is able to clearly read the information marked on the label D to identify the applicable specification exclusively provided by the basic hoisting ring before selecting a correct basic hoisting ring, the operator will pick up the basic hoisting ring complying with safety specification applicable to the work piece S after having made right decisions depending on the weight of the work piece S or any other conditions. The present invention by minimizing the chance of selecting a basic hoisting ring that is not applicable for the work piece S due to errors in reading the information effectively prevents possible dangers including broken or falling basic hoisting ring, drop or inclination of the work piece onto the floor in the course of the hoisting operation thus to significantly improve work safety in hoisting a heavy-duty work piece in a shop area. Therefore, this application for a utility patent is duly filed accordingly.

I claim:

1. A basic hoisting ring labeling means to provide a clear and permanent label to identify the basic hoisting ring includes a hook, a cylindrical base, a threaded bolt, and an annual recess; the hook made in an inverse U shape with both straight sides each provided with an inwardly protruding hooking portion, the hook being coupled to both sides of the cylindrical base by means of those two hooking portions; the threaded bolt being inserted into a middle section of the cylindrical base with a lower section of the threaded portion exposed from a bottom of the cylindrical base to engage with a thread slot disposed on top of a work piece to secure both of the work piece and the cylindrical base in position to each other; the annual recess being disposed on a middle section of the cylindrical base to define a divide between a bottom of the recess and a surface of the cylindrical base; multiple letters and numbers to label necessary information specific to the basic hoisting ring being provided, on the bottom of the recess to shield from impacts and friction from and with other work objects.

2. The basic hoisting ring labeling means as claimed in claim 1, wherein the labeling of the specification of the basic hoisting ring printed on the bottom of the annular recess or the bottom of the annular recess is highlighted by painting a particular base color to allow easier identification by an operator.
